(19) United States
(12) Patent Application Publication
(10) Pub. No.: US 2007/0114934 A1
(43) Pub. Date: May 24, 2007

(54) Plasma display panel (PDP) suitable for monochromatic display

(76) Inventor: Sanghoon Lim, Yongin-si (KR)

Correspondence Address: Robert E. Bushnell, Suite 300, 1522 K Street, N.W., Washington, DC, 20005, US

(21) Appl. No.: 11/602,316

(22) Filed: Nov. 21, 2006

(30) Foreign Application Priority Data
Nov. 22, 2005 (KR) 10-2005-0111910

(51) Int. Cl. H01J 17/49

(52) U.S. Cl. 313/584

(57) ABSTRACT

A Plasma Display Panel (PDP) has a structure in which three discharge cells are adjacent to one another and are arranged in a triangular form, thereby forming one pixel, wherein in pixels arranged in a first direction, an average of 1.5 address electrodes are assigned to each pixel, which belong to the group of electrodes and have a specific angle in the first direction with respect to a surface parallel to the substrates, and at least four sustain electrodes pass through each pixel. In addition, even numbered or odd numbered electrodes of scan electrodes that are included in the sustain electrodes are sequentially connected to terminals of a scan electrode driving module, and the rest of the electrodes are sequentially connected to the next terminals of the scan electrode driving module. Accordingly, the number of address electrodes for implementing a screen having the same horizontal resolution and the number of driving circuit chips required to drive the address electrodes are reduced, and monochromatic images can be effectively displayed through simple changes of the connection structure between the scan electrodes and the terminals ofthe scan electrode driver, to reduce power consumption and heat release rate.

### CLAIM OF PRIORITY

This application makes reference to, incorporates the same herein, and claims all benefits accruing under 35 U.S.C.§119 from an application for PLASMA DISPLAY PANEL SUITABLE FOR MONOCHROMATIC DISPLAY earlier filed in the Korean Intellectual Property Office on the 22 Nov. 2005 and there duly assigned Ser. No. 10-2005-0111910.

### BACKGROUND OF THE INVENTION

1. Field of the Invention

The present invention relates to a Plasma Display Panel (PDP), and more particularly, the present invention relates to a PDP which has scan electrodes driven to enhance its monochromatic display efficiency.

2. Description of the Related Art

Plasma display devices are flat display devices using a Plasma Display Panel (PDP) in which barrier ribs and driving electrodes are formed between two substrates arranged to face each other with a specific gap therebetween, a discharge gas is infused therein, and the two substrates are sealed together. In a plasma display device, a PDP is formed, and elements required for implementing the display screen are then installed, such as driving circuits connected to the electrodes of the PDP.

In the PDP, a number of pixels for displaying images on the screen are vertically and horizontally arranged in cyclical and regular manners to form a matrix pattern. Each pixel is driven in a manual matrix manner in which a voltage is simply supplied to the electrodes without any active elements for driving the pixels. According to the type of a voltage signal for driving each electrode, the PDP can be classified either as a Direct Current (DC) PDP or an Alternating Current (AC) PDP. In addition, according to the disposition of two electrodes to which a discharge voltage is supplied, the PDP can be classified either as an opposed discharge type PDP or a surface discharge type PDP.

In the AC PDP, electrodes are covered by a dielectric layer so that the electrodes naturally have electrostatic capacity, a current flowing through the electrodes is limited, and the electrodes are easily protected from ion bombardment when a discharge takes place. As a result, a lifespan of the electrodes is extended. In a typical AC surface discharge type PDP, a plurality of address electrodes are vertically formed in the inner side of one of the two substrates to be parallel to one another. A common electrode and a scan electrode, which may be respectively referred to as a sustain electrode and a display electrode, are alternately horizontally formed in the inner side of the same substrate or the other substrate to be parallel to one another.

In general, a matrix type pixel arrangement is determined by forming barrier ribs and electrodes. A color pixel includes three discharge cells emitting separate visible light beams of different colors. Three color pixels may be disposed side by side, or disposed in a triangular form. The discharge cells may be formed in a rectangular or hexagonal form.

The barrier ribs may be stripe types in which the barrier ribs are formed in a straight line parallel to an address electrode in a column direction, or a grid type in which each cell is arranged in a row direction and a column direction to define a cell. Furthermore, the barrier ribs may have a meander structure in which the stripe type and the grid type are combined, and a discharge cell is formed in a section that is widened by repeatedly narrowing and widening the width between stripe type barrier ribs.

FIG. 1 is a schematic plan view of an electrode structure of each pixel of an example of a matrix type PDP.

FIG. 2 a schematic plan view of an electrode structure of each pixel of an example of a PDP having hexagonal discharge cells arranged in a triangular form.

FIG. 3 is a view of a connection structure for performing a method of separately scanning odd numbered rows and even numbered rows of discharge cells

In the aforementioned pixel structure, since a single address electrode Aₘ passes the discharge cells representing the same color, when the entire screen displays a monochromatic image, a voltage that is supplied to the address electrodes is not changed, and switching does not take place in each address electrode. Accordingly, a circuit operation needed for switching each address electrode and power consumption are not needed.

However, in the PDPs of FIGS. 1 and 2, three address electrodes A that are vertically formed pass through each pixel including three discharge cells. Techniques for obtaining high definition and high brightness have been continuously developed for the plasma display device. In practice, to achieve a high definition screen, the number of horizontally arranged pixels and a pixel density increase, thereby increasing the number of the address electrodes.

However, unlike sustain electrodes Xₙ and Yₙ, when many address electrodes are provided, power consumption increases due to the characteristic of the address electrodes, and a heat release rate increases. In particular, when the number of the address electrodes A increases, and the gap between the address electrodes A decreases, a parasitic capacitance increases. As a result, power consumption and a heat release rate for each address electrode, which can be estimated from CV²f, increase sharply and signal characteristics may deteriorate, where C is a coefficient of capacity, V is a voltage supplied to an address electrode, and f is a frequency.

Therefore, there is a need for a technique in which the number of address electrodes is reduced while resolution or the number of pixels is maintained to be the same.

On the other hand, techniques in which the number of electrodes is maintained to be the same while resolution is improved include an Alternative LIghtening of Surface (ALIS) driving method. In the ALIS driving method, the number of the horizontally formed sustain electrodes that are vertically arranged is maintained to be the same, the interval of the sustain electrodes is constant, the vertically formed barrier ribs are removed, and the discharge takes place in the place where there were the vertically formed barrier ribs. Thereby, the vertical resolution may be substantially doubled.

In order to perform the ALIS driving method, common electrodes X are divided into odd numbered rows and even numbered rows and connected to separate common electrode drivers XDₒ and XDₑ. Thereby, two different sustain discharge voltages are supplied to the common electrodes X to independently drive the adjacent rows.

Similarly, in FIG. 3, a connection structure is shown for a method in which the discharge cells are divided into odd numbered rows and even numbered rows of the discharge cells and are alternately scanned.

### SUMMARY OF THE INVENTION

The present invention provides a Plasma Display Panel (PDP) that maintains the number of switching operations at a minimum when displaying monochromatic images on a screen in a changed electrode structure.

The present invention also provides a PDP that has an electrode structure capable of reducing the number of address electrodes needed for driving pixels while maintaining the number of pixels to be the same in a screen and effectively displays monochromatic images on the screen.

According to one aspect of the present invention, a Plasma Display Panel (PDP) is provided including: two substrates; a plurality of barrier ribs arranged between the two substrates to define spaces between the two substrates as discharge cells; a group of electrodes arranged on at least one of the two substrates and the plurality of barrier ribs, the group of electrodes adapted to induce a discharge in the discharge cells; a phosphor layer arranged in each of the discharge cells; and a discharge gas contained within each discharge cell; three discharge cells are arranged adjacent to one another in a triangular form to define a respective pixel; in pixels arranged in a first direction, an average of 1.5 address electrodes are assigned to each pixel, the address electrodes of the group of electrodes having a specific angle in the first direction with respect to a surface parallel to the two substrates, and at least four sustain electrodes related to a sustain discharge from the group of electrodes pass through each pixel; and one of either even numbered or odd numbered scan electrodes included in the sustain electrodes are adapted to be sequentially connected to respective terminals of a scan electrode driving module, and the other of the either even numbered or odd numbered scan electrodes are adapted to be sequentially connected to respective next terminals of the scan electrode driving module.

The pixels are preferably arranged in either a delta shape or a nabla shape; pixels arranged in the first direction preferably include pixels alternately arranged in the delta and nabla shapes; and two of the address electrodes preferably pass through each of the pixels.

The pixels arranged in the first direction preferably include two rows of discharge cells adjacent to each other in a second direction having a specific angle with respect to the first direction at a surface parallel to the substrates; discharge cells emitting three colors of light beams are preferably sequentially and cyclically arranged in the rows of discharge cells, the rows of discharge cells adjacent each other in the second direction being preferably shifted by ½ cycle in the first direction, 1 cycle being an entire width of the discharge cells emitting the three colors of light beams; and the address electrodes are preferably respectively assigned one by one to each discharge cell of the rows of discharge cells, two of the sustain electrodes preferably passing through each discharge cell.

The discharge cells are preferably arranged in either a hexagonal or rectangular form.

The address electrodes are preferably perpendicular to the first direction and pass between vertical barrier ribs that are parallel to the address electrodes with respect to a direction perpendicular to the two substrates.

A branch electrode arranged to branch off from the address electrodes is preferably included within the discharge cells through which the address electrodes pass. The branch electrode is preferably arranged to branch off from the address electrodes towards a center of the discharge cells.

The sustain electrodes preferably include alternately arranged scan electrodes and common electrodes in the second direction perpendicular to the first direction. Each sustain electrode preferably passes through only one row of discharge cells arranged in the first direction. Each sustain electrode preferably includes a bus electrode and a transparent electrode in contact with the bus electrode, the transparent electrode being wider than the bus electrode. Each sustain electrode preferably includes two common electrodes horizontally passing through upper and lower portions of each discharge cell arranged in the first direction and a scan electrode horizontally passing through a center of each discharge cell.

According to another aspect of the present invention, a Plasma Display Panel (PDP) is provided including: two substrates; a plurality of barrier ribs arranged between the two substrates to define spaces between the two substrates as discharge cells; a group of electrodes arranged on at least one of the two substrates and the plurality of barrier ribs, the group of electrodes adapted to induce a discharge in the discharge cells; a phosphor layer arranged in each of the discharge cells; and a discharge gas contained within each discharge cell; three discharge cells are arranged adjacent to one another in a triangular form to define a respective pixel; in pixels arranged in a first direction, a ratio of a number of address electrodes belonging to the group of electrodes and having a specific angle in the first direction with respect to a surface parallel to the substrates, with respect to a number of sustain electrodes arranged in the first direction and related to a sustain discharge, is either 3:8 or 1:4, and one of either even numbered or odd numbered scan electrodes included in the sustain electrodes are adapted to be sequentially connected to respective terminals of a scan electrode driving module, and the other of either even numbered or odd numbered scan electrodes are adapted to be sequentially connected to respective next terminals of the scan electrode driving module.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic plan view of an electrode structure of each pixel of an example of a matrix type PDP;

FIG. 2 is a schematic plan view of an electrode structure of each pixel of an example of a PDP having hexagonal discharge cells arranged in a triangular form;

FIG. 3 illustrates a connection structure for performing a method of separately scanning odd numbered rows and even numbered rows of discharge cells;

FIG. 4 is a top plan view of a structure of barrier ribs and electrodes and connections between scan electrodes and scan electrode driver terminals that are simplified with respect to the pixels within a specific screen area according to a comparative example; and

FIG. 5 is a top plan view a structure of barrier ribs and electrodes and connections between scan electrodes and scan electrode driver terminals that are simplified with respect to the pixels within a specific screen area according to an embodiment of the present invention.

### DETAILED DESCRIPTION OF THE INVENTION

Hereinafter, the present invention is described in detail by explaining comparative examples and exemplary embodiments of the present invention with reference to the accompanying drawings.

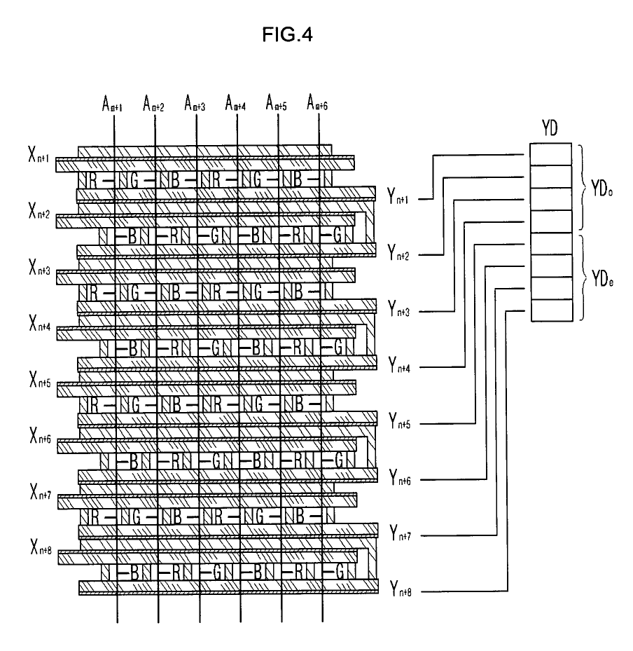

FIG. 4 is a top plan view of a structure of barrier ribs and electrodes and connections between scan electrodes and scan electrode driver terminals that are simplified with respect to the pixels within a specific screen area according to a comparative example.

Referring to FIG. 4, each discharge cell has a rectangular form, and three discharge cells disposed up and down in two rows are combined to form a pixel arranged in a triangular form. In a row of discharge cells, three types of discharge cells emitting three types of visible light beams, for example, red (R), green (G), and blue (B), are sequentially disposed in a first direction, or in a horizontal direction with respect to a screen in the present comparative example. Furthermore, in another row under the aforementioned row, the light beams of R, G, and B are sequentially and cyclically arranged. The half width of one cycle having R, G, and B components is shifted in the first direction, that is, the horizontal direction.

Two horizontally adjacent discharge cells in the upper row, for example, R and G, form a nabla (∇) shape together with a discharge cell in the lower row adjacent to the two discharge cells, thereby forming a pixel. A next discharge cell in the upper row, for example, B, forms a horizontally arranged delta (Δ) shape together with two discharge cells in a lower row adjacent to this discharge cell, for example, R and G, thereby forming a next pixel. These two triangular shapes are cyclically repeated to form an overall horizontal pixel arrangement.

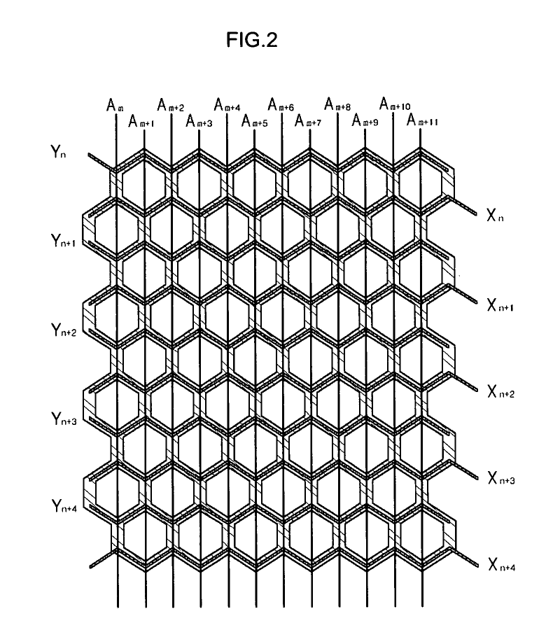

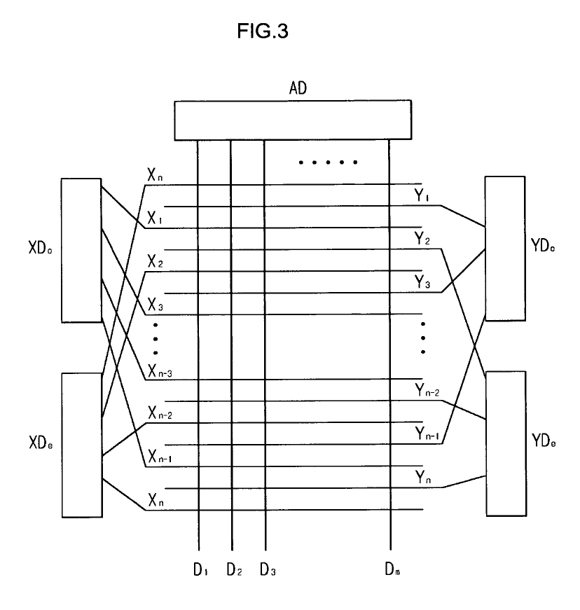

Address electrodes Aₘ formed in a second direction having a specific angle with respect to the first direction, or in a vertical direction of FIG. 3, are formed within a surface parallel to a substrate surface. From the view point of one discharge row, one address electrode A is assigned to one discharge cell. However, from the view point of a pixel unit, six address electrodes Aₘ vertically formed in the second direction (i.e. vertically direction) are assigned to four pixels formed in the first direction (i.e. horizontal direction). Thus, an average number of the address electrodes assigned to each pixel is 1.5. As a result, the number of the address electrodes for each pixel is reduced by half, in comparison with that of FIG. 2.

The address electrodes are located in a stripe shape, between vertically formed barrier ribs among the barrier ribs defining discharge cells. Specifically, the address electrodes pass between the vertically formed barrier ribs located in adjacent upper and lower rows, so that the address electrodes are not overlapped with the vertically formed barrier ribs. In order to enhance discharge accuracy, a branch electrode is formed perpendicular to a main address electrode A in a center direction of vertically formed discharge cells. Thus, branch electrodes which are adjacent up and down in one address electrode are directed in opposite directions. The shape of the branch electrodes, the number of the branch electrodes, and the angle with respect to the main address electrode may vary. The address electrodes are generally formed in a rear substrate, and a dielectric layer, a barrier rib, and a phosphor layer may be formed on the rear substrate on which the address electrodes are formed.

Sustain electrodes X and Y are formed horizontally in FIG. 3, and are parallel to the horizontal barrier ribs 110 defining each discharge cell. Specifically, in the present comparative example, when a plurality of horizontal barrier ribs is vertically arranged, common electrodes Xₙ and scan electrodes Yₙ are disposed one by one in a discharge cell space between the barrier ribs. Consequently, one address electrode and one scan electrode pass through one discharge cell. Thus, each discharge cell can be independently driven irrespective of other discharge cells, and a pixel that is a combination of discharge cells can be independently driven irrespective of other pixels.

The sustain electrodes X and Y include a bus electrode on a surface of the front substrate and a transparent electrode which comes in contact with or overlaps with the bus electrode and has a wide width that is extended by a specific width in a center direction of the discharge cell. Although not shown, the sustain electrodes may be formed only with a good conductive electrode, such as a metal electrode, without an additional transparent electrode. Since a size of a discharge cell is minimized to cope with a high definition panel, for an opposed discharge, the sustain electrodes may be formed on both lateral sides of a barrier rib rather than on the surface of a substrate. To avoid a dielectric breakdown due to the barrier rib, the thickness and permittivity of the barrier rib have to be taken into account.

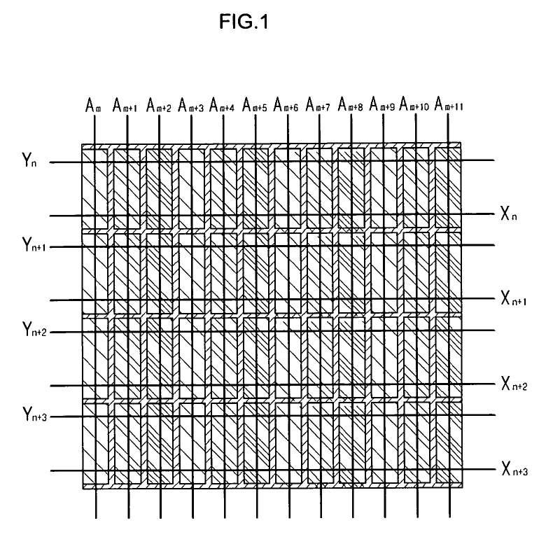

In the present comparative example, four sustain electrodes, which are two common electrodes and two scan electrodes, are assigned through two upper and lower rows of the discharge cells which form a pixel by combining discharge cells. In a screen area where four pixels are horizontally arranged and four pixels are vertically arranged, the total number of vertically formed address electrodes is 6, and the total number of horizontally formed sustain electrodes is 16, that is, 8 common electrodes and 8 scan electrodes. Thus, the ratio of the number of address electrodes with respect to the number of sustain electrodes is 3:8. In comparison with the PDP of FIG. 1 or 2, for the same number of pixels, the number of address electrodes is reduced by ½, and the number of sustain electrodes is doubled.

The scan electrode of each discharge cell is sequentially connected to a terminal of a scan driver. Thus, a scan voltage is sequentially supplied to vertically arranged scan electrodes at specific intervals according to operation of the scan driver.

According to this electrode arrangement, the number of sustain electrodes increases, but the overall power consumption is reduced since power supplied through the sustain electrodes is circulated and is thereby recyclable. The number of expensive Tape Carrier Packages (TCPs) for driving the address electrodes can be also reduced, resulting in saving component costs. In a 4:3 screen or a 16:9 screen, the number of address electrodes is generally greater than the number of scan electrodes. Considering the size of a circuit board for controlling each electrode terminal, in terms of a driving circuit design, it is preferable to increase the number of scan electrodes that can be further increased, rather than increasing the number of address electrodes that have little space available on the board.

In the present comparative example, problems of PDPs having the electrode structure of FIGS. 1 and 2, that is, problems due to the large number of address electrodes can be solved by reducing the number of address electrodes while maintaining the number of pixels.

However, unlike other PDPs, in the present comparative example, one address electrode alternately passes through discharge cells representing two colors. Accordingly, in the PDP that has the aforementioned structure including the barrier ribs and the electrodes, switching occurs abundantly.

For example, considering a first address electrode, when a scan voltage is supplied to a first scan electrode Yₙ+1, since the first address electrode passes through an R discharge cell at the first row of the discharge cells, a switch-on voltage is supplied to display R color.

However, when the scan voltage is sequentially supplied to the second scan electrode Yₙ+2, since the first address electrode passes through a B discharge cell, a switch-off voltage is supplied. Accordingly, a switching operation for the address electrode is performed, once. When there are ten pixels in a vertical direction of the screen, since the first address electrode passes through the area in which twenty R discharge cells and nineteen B discharge cells are alternately arranged, nineteen switching operations are performed through the first supplied voltage.

One frame generally includes eight sub-frames. Since the address discharge takes place in every sub-frame, the first address electrode performs 19×8=152 switching operations for displaying R color on the entire screen. The aforementioned switching operation is similarly supplied to another address electrode. When the corresponding address electrode does not pass through the R discharge cells, since the voltage is maintained in a switch-off state, the switching operation is not performed.

When the switching operations are performed multiple times, a large load is presented to the driver for driving the corresponding address electrode. When the large load is presented to the driver, power consumption and heat release rate increase, thereby reducing the lifespan of the driver and deteriorating the performance thereof.

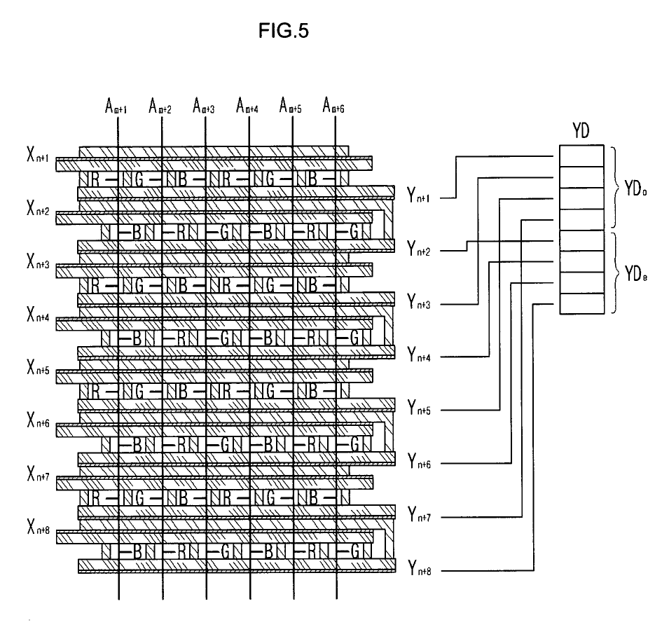

FIG. 5 is a top plan view of a structure of barrier ribs and electrodes and connections between scan electrodes and scan electrode driver terminals that are simplified with respect to the pixels within a specific screen area according to an embodiment of the present invention.

Most elements in the embodiment of FIG. 5 may be constructed in the same pattern as those in the comparative example of FIG. 4, except for the terminal connection structure between the scan electrodes and the scan electrode driver.

In FIG. 5, barrier ribs are formed so that each discharge cell has a rectangular form, and three discharge cells disposed up and down in two rows are combined to form a pixel arranged in a triangular form.

From the view point of one discharge row, one address electrode is assigned to one discharge cell. However, from the view point of a pixel unit, six address electrodes formed vertically are assigned to four pixels formed horizontally. Thus, an average number of the address electrodes assigned to each pixel is 1.5.

Although not shown, in another embodiment, barrier ribs are formed so that each discharge cell has a hexagonal form, and three discharge cells disposed up and down in adjacent rows are combined to form a pixel arranged in a triangular form.

In the hexagonal discharge cell structure, the address electrodes form a stripe shape, and are located between the vertically formed barrier ribs among the barrier ribs that have a hexagonal shape to define discharge cells. In each address electrode, a branch electrode is formed in a center direction of the discharge cells through which the address electrodes pass. An address discharge can take place in a wider area of the discharge cell due to the branch electrode. The branch electrode may also allow a display discharge to take place in a wider area.

A sustain electrode is formed horizontally, is not overlapped with barrier ribs that form a hexagonal discharge cell in a zigzag manner, and passes through upper and lower portions of vertically formed barrier ribs while two sustain electrodes, that is, a scan electrode and a common electrode, are separated from each other by a specific distance in each hexagonal discharge cell. In the present embodiment, the sustain electrode has a wide width and is made of one material, but as shown in FIG. 3, the sustain electrode may include a bus electrode and a transparent electrode that extends by a specific width towards the center of upper and lower discharge cells in contact with the bus electrode.

In the present embodiment of FIG. 5, as in the embodiment of FIG. 4, in a screen area where four pixels are horizontally arranged and four pixels are vertically arranged, the total number of vertically formed address electrodes is 6, and the total number of horizontally formed sustain electrodes is 16, that is, 8 common electrodes and 8 scan electrodes. Thus, the ratio of the number of the address electrodes with respect to the number of the sustain electrodes is 3:8.

However, the terminal connection structure between the scan electrodes and the scan electrode driver in the embodiment of FIG. 5 is different from that in the comparative example of FIG. 4. Specifically, scan electrodes Yₙ+1, Yₙ+3, Yₙ+5, and Yₙ+7 of the odd numbered rows of the discharge cells are connected to sequentially formed terminals of the scan electrode driver, and scan electrodes Yₙ+2, Yₙ+4, Yₙ+6, and Yₙ+8 of the even numbered rows of the discharge cells are connected to the next sequentially formed terminals of the scan electrode driver. Accordingly, when a scan voltage is sequentially supplied to the terminals of the scan electrode driver, the odd numbered rows of the discharge cells of the panel are firstly scanned, and then, the even numbered rows of the discharge cells are secondly scanned, like in interlaced scanning used for a Cathode Ray Tube (CRT).

Considering switching of first address electrode, when the scan voltage is supplied to the first scan electrode Yₙ+1, since the first address electrode passes through an R discharge cell, the scan voltage is sequentially supplied to the third, fifth, and seventh scan electrodes while a switch-on voltage is being supplied. Since the first address electrode passes through R discharge cell in the corresponding row of the discharge cells in which the aforementioned scan electrodes are formed, the first address electrode is maintained to be switched on. Accordingly, the first address electrode is maintained to be switched on, and a switching operation is not performed, while scanning the odd numbered rows of the discharge cells.

When the scan voltage is supplied to the next terminals of the scan electrode driver, in the panel, the scan voltage is supplied to the second scan electrode that is the first scan electrode of the even numbered rows of the discharge cells. In the second row of the discharge cells, since the first address electrode passes through a B discharge cell, in order to display R color, the voltage of the first address electrode has to be switched off. Accordingly, the switching operation is performed once.

Thereafter, even though the scan voltage is sequentially supplied to the scan electrodes in the even numbered rows of the discharge cells, since the first address electrode passes B discharge cell, the first address electrode is maintained to be switched off, and the switching operation is not performed. Thus one sub-frame is scanned. Since one frame includes eight sub-frames, the switching operations are performed in the first address electrode as many times as the number of sub-frames (eight times).

When comparing this result with that of the comparative example, in the screen in which ten pixels are horizontally arranged and twenty rows of the discharge cells are arranged, the number of the switching operations of the first address electrode is reduced to 1/19 times of that of the comparative example.

The plane structure of FIG. 5 may be formed by constructing a layer structure in various ways. For example, an electrode may be formed only on a front or rear substrate constituting a panel. Alternatively, the electrode may be formed on two substrates. Furthermore, since the distance between discharge electrodes becomes short as high definition type becomes prevalent, to increase discharge efficiency, two types of sustain electrodes may be formed on barrier ribs to obtain a long gap and a surface discharge type panel in which the distance between discharge electrodes is increased.

Additionally, the address electrode may be formed in such a way that the rear substrate is opaquely formed with a metal layer, a dielectric layer and a barrier rib are formed thereon, and a phosphor layer is laminated thereon, thereby constituting the rear substrate. In the front substrate, two types of an electrode group constituting a sustain electrode are formed with a metal or a transparent conductive layer, such as a metal or Indium Tin Oxide (ITO), and a dielectric layer or a protective layer may be formed thereon. A layer pattern, such as an electrode layer or a barrier rib, may be formed using lithography or photolithography. The protecting layer or its equivalent may be formed by various methods, such as sputtering and deposition. Such structure and methods are well-known to those skilled in a PDP field, and thus, a detailed description thereof has been omitted.

The present invention may be embodied in various forms for planar construction. For example, when the sustain electrodes are located at up and down barrier ribs and made of metal, a center electrode that passes through the center of the discharge cell is formed between the metal electrodes and operates as the scan electrode. In the aforementioned structure, the terminals of the scan electrode driver are sequentially connected to the scan electrodes of the odd numbered rows of the discharge cells at first. Subsequently, the next terminals of the scan electrode driver are sequentially connected to the scan electrodes of the even numbered rows of the discharge cells. Since the scan electrodes may operate as the sustain electrode according to the supplied voltage during a sustain discharge period, in the present embodiment, the total number of address electrodes is 6, and the total number of sustain electrodes is 24. Thus, an average ratio of the number of address electrodes with respect to the number of sustain electrodes assigned to each pixel is 1:4.

Even though, in the aforementioned embodiments, the scan electrodes that pass through the odd numbered rows of the discharge cells are first connected to the terminals of the scan electrode driver, it will be apparent that inversely, the scan electrodes that pass through the even numbered rows of the discharge cells may first be connected to the terminals of the scan electrode driver.

Accordingly, in a PDP of the present invention, the number of address electrodes for implementing a screen having the same horizontal resolution and the number of driving circuit chips required to drive the address electrodes can be reduced, and monochromatic images can be effectively displayed through simple changes of the connection structure between the scan electrodes and the terminals of the scan electrode driver.

Therefore, the number of address electrodes, which consume power and generate heat the most in the PDP, can be reduced, and in monochromatic image display, loads of the driver that are consumed for switching of the address electrodes can be also reduced, thereby reducing power consumption and heat release rate.

What is claimed is:

1. A Plasma Display Panel (PDP), comprising:
two substrates;
a plurality of barrier ribs arranged between the two substrates to define spaces between the two substrates as discharge cells;
a group of electrodes arranged on at least one of the two substrates and the plurality of barrier ribs, the group of electrodes adapted to induce a discharge in the discharge cells;
a phosphor layer arranged in each of the discharge cells; and
a discharge gas contained within each discharge cell;
wherein three discharge cells are arranged adjacent to one another in a triangular form to define a respective pixel;
wherein, in pixels arranged in a first direction, an average of 1.5 address electrodes are assigned to each pixel, the address electrodes of the group of electrodes having a specific angle in the first direction with respect to a surface parallel to the two substrates, and wherein at least four sustain electrodes related to a sustain discharge from the group of electrodes pass through each pixel; and
wherein one of either even numbered or odd numbered scan electrodes included in the sustain electrodes are adapted to be sequentially connected to respective terminals of a scan electrode driving module, and the other of the either even numbered or odd numbered scan electrodes are adapted to be sequentially connected to respective next terminals of the scan electrode driving module.

2. The PDP according to claim 1,
wherein the pixels are arranged in either a delta shape or a nabla shape;
wherein pixels arranged in the first direction include pixels alternately arranged in the delta and nabla shapes; and
wherein two of the address electrodes pass through each of the pixels.

3. The PDP according to claim 1,
wherein the pixels arranged in the first direction include two rows of discharge cells adjacent to each other in a second direction having a specific angle with respect to the first direction at a surface parallel to the substrates;
wherein discharge cells emitting three colors of light beams are sequentially and cyclically arranged in the rows of discharge cells, the rows of discharge cells adjacent each other in the second direction being shifted by ½ cycle in the first direction, 1 cycle being an entire width of the discharge cells emitting the three colors of light beams; and
wherein the address electrodes are respectively assigned one by one to each discharge cell of the rows of discharge cells, two of the sustain electrodes passing through each discharge cell.

4. The PDP according to claim 1, wherein the discharge cells are arranged in either a hexagonal or rectangular form.

5. The PDP according to claim 2, wherein the address electrodes are perpendicular to the first direction and pass between vertical barrier ribs that are parallel to the address electrodes with respect to a direction perpendicular to the two substrates.

6. The PDP according to claim 3, wherein the address electrodes are perpendicular to the first direction and pass between vertical barrier ribs that are parallel to the address electrodes with respect to a direction perpendicular to the two substrates.

7. The PDP according to claim 2, wherein a branch electrode arranged to branch off from the address electrodes is included within the discharge cells through which the address electrodes pass.

8. The PDP according to claim 7, wherein the branch electrode is arranged to branch off from the address electrodes towards a center of the discharge cells.

9. The PDP according to claim 3, wherein a branch electrode arranged to branch off from the address electrodes is included within the discharge cells through which the address electrodes pass.

10. The PDP according to claim 9, wherein the branch electrode is arranged to branch off from the address electrodes towards a center of the discharge cells.

11. The PDP according to claim 1, wherein the sustain electrodes comprise alternately arranged scan electrodes and common electrodes in the second direction perpendicular to the first direction.

12. The PDP according to claim 11, wherein each sustain electrode passes through only one row of discharge cells arranged in the first direction.

13. The PDP according to claim 11, wherein each sustain electrode comprises a bus electrode and a transparent electrode in contact with the bus electrode, the transparent electrode being wider than the bus electrode.

14. The PDP according to claim 1, wherein each sustain electrode comprises two common electrodes horizontally passing through upper and lower portions of each discharge cell arranged in the first direction and a scan electrode horizontally passing through a center of each discharge cell.

15. A Plasma Display Panel (PDP), comprising:
two substrates;
a plurality of barrier ribs arranged between the two substrates to define spaces between the two substrates as discharge cells;
a group of electrodes arranged on at least one of the two substrates and the plurality of barrier ribs, the group of electrodes adapted to induce a discharge in the discharge cells;
a phosphor layer arranged in each of the discharge cells; and
a discharge gas contained within each discharge cell;
wherein three discharge cells are arranged adjacent to one another in a triangular form to define a respective pixel;
wherein, in pixels arranged in a first direction, a ratio of a number of address electrodes belonging to the group of electrodes and having a specific angle in the first direction with respect to a surface parallel to the substrates, with respect to a number of sustain electrodes arranged in the first direction and related to a sustain discharge, is either 3:8 or 1:4; and
wherein one of either even numbered or odd numbered scan electrodes included in the sustain electrodes are adapted to be sequentially connected to respective terminals of a scan electrode driving module, and the other of either even numbered or odd numbered scan electrodes are adapted to be sequentially connected to respective next terminals of the scan electrode driving module.

16. The PDP according to claim 15,
wherein the pixels are arranged in either a delta shape or a nabla shape;
wherein pixels arranged in the first direction include pixels alternately arranged in the delta and nabla shapes; and
wherein two of the address electrodes pass through each of the pixels.

17. The PDP according to claim 15,
wherein the pixels arranged in the first direction include two rows of discharge cells adjacent to each other in a second direction having a specific angle with respect to the first direction at a surface parallel to the substrates;
wherein discharge cells emitting three colors of light beams are sequentially and cyclically arranged in the rows of discharge cells, the rows of discharge cells adjacent each other in the second direction being shifted by ½ cycle in the first direction, 1 cycle being an entire width of the discharge cells emitting the three colors of light beams; and
wherein the address electrodes are respectively assigned one by one to each discharge cell of the rows of discharge cells, two of the sustain electrodes passing through each discharge cell.

18. The PDP according to claim 15, wherein the discharge cells are arranged in either a hexagonal or rectangular form.

19. The PDP according to claim 15, wherein each sustain electrode comprises a bus electrode and a transparent electrode in contact with the bus electrode, the transparent electrode being wider than the bus electrode.

20. The PDP according to claim 15, wherein each sustain electrode comprises two common electrodes horizontally passing through upper and lower portions ofeach discharge cell arranged in the first direction and a scan electrode horizontally passing through a center of each discharge cell.
